(19) United States
(12) Patent Application Publication
(10) Pub. No.: US 2025/0167466 A1
(43) Pub. Date: May 22, 2025

(54) BYPASS POKE HOME CONNECTOR

(71) Applicant: Kyocera AVX Components Corporation, Fountain Inn, SC (US)

(72) Inventor: Brent LYBRAND, Fountain Inn, SC (US)

(21) Appl. No.: 18/784,657

(22) Filed: Jul. 25, 2024

Related U.S. Application Data
(60) Provisional application No. 63/600,440, filed on Nov. 17, 2023.

(51) Int. Cl. H01R 4/48

(52) U.S. Cl. CPC H01R 4/4819

(57) ABSTRACT

A wire-to-wire connector includes a housing defining a first port and a second port, and a contact member disposed within the housing. The contact member defines a first channel and a second channel separated by a wall, where the first channel defines a first axis and the second channel defines a second axis offset from the first axis, and where the first axis and the second axis are substantially parallel. The first channel is aligned with the first port and the second channel is aligned with the second port.

### CROSS REFERENCE TO RELATED APPLICATIONS

The present application claims priority to U.S. Provisional Application No. 63/600,440 filed on Nov. 17, 2023, the contents of which are incorporated herein in their entirety.

### FIELD

The present disclosure relates generally to the field electrical connectors, and more particularly to a type of connector used to connect an electrical wire to an electrical component.

### BACKGROUND

The following description is provided to assist the understanding of the reader. None of the information provided or references cited is admitted to be prior art.

Many connector types can be used to form connections between an insulated wire and any manner of electronic or electrical component. These connectors can be available as sockets, plugs, and shrouded headers in a variety of sizes, pitches, and plating options. Although necessary for forming electrical connections, some connectors can have substantial footprints to accommodate receiving wires-particularly when wires must extend in opposing directions. When wires are dissimilar (e.g., in size), multiple connectors may be needed, which can often require a larger footprint than single connectors.

Accordingly, it would be advantageous to provide a connector having a minimal footprint that can facilitate wire-to-wire connections, including wires of dissimilar size.

### SUMMARY

One aspect of the present disclosure relates to a wire-to-wire connector. The connector includes a housing defining a first port and a second port, and a contact member disposed within the housing. The contact member defines a first channel and a second channel separated by a wall, where the first channel defines a first axis and the second channel defines a second axis offset from the first axis, and where the first axis and the second axis are substantially parallel. The first channel is aligned with the first port and the second channel is aligned with the second port.

In various embodiments, the housing includes a first end and a second end opposite the first end. In some embodiments, the housing includes a first portion and a second portion, the first portion being structured to couple to the second portion. In other embodiments, the first portion includes a first tab and a second tab, where the second portion includes a first groove and a second groove, and where the first tab is structured to engage with the first groove and the second tab is structured to engage with the second groove. In yet other embodiments, the first tab and the first groove are disposed at the first end, and the second tab and the second groove are disposed at the second end. In various embodiments, the first port is disposed at the first end and the second port is disposed at the second end. In some embodiments, the first port and the second port are formed between the first portion and the second portion. In other embodiments, the contact member includes a first beam and a second beam, the first beam forming the first channel and the second beam forming the second channel. In yet other embodiments, each of the first beam the second beam includes a first section and a second section, where the first section extends in a direction substantially perpendicular to the wall and the second section extends from the first section in a direction substantially parallel to the wall. In various embodiments, the first section of the first channel defines a width of the first channel and the second section of the first channel defines a length of the first channel, where the first section of the second channel defines a width of the second channel and the second section of the second channel defines a length of the second channel. In some embodiments, the second section is tapered such that a distance between the second section and the wall decreases with increased distance from the first section.

Another aspect of the present disclosure relates to a wire-to-wire connector system. The connector system includes a first port and a second port opposite the first port, a first wire, and a second wire. The first wire is structured to be received in the first port and the second wire is structured to be received in the second port to form an electrical connection with the first wire. The first port is aligned along a first axis and the second port is aligned along a second axis, where the first axis and the second axis are substantially parallel.

In various embodiments, the connector includes a housing defining a first port and a second port, and a contact member disposed within the housing. The contact member defines a first channel and a second channel separated by a wall, where the first channel defines a first axis and the second channel defines a second axis offset from the first axis, and where the first axis and the second axis are substantially parallel. The first channel is aligned with the first port and the second channel is aligned with the second port. In some embodiments, the contact member is positioned within a recess disposed within a portion of the housing. In other embodiments, at least one of the first wire or the second wire is solid. In yet other embodiments, at least one of the first wire or the second wire is stranded. In various embodiments, the first wire and the second wire are different sizes. In some embodiments, the housing includes a cover and a base, where the cover is structured to couple to the base, and where the contact member is positioned within the base. In other embodiments, the contact member consists of a single component. In yet other embodiments, the contact member includes a first beam and a second beam, where the first beam forms the first channel and the second beam forms the second channel. Each of the first beam the second beam includes a first section and a second section, the first section extending in a direction substantially perpendicular to the wall and the second section extending from the first section in a direction substantially parallel to the wall.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a wire connector system in a disconnected arrangement, according to an exemplary embodiment.

FIG. 2 is a perspective view of the wire connector system of FIG. 1 in a connected arrangement, according to an exemplary embodiment.

FIG. 3 is a perspective view of the wire connector system of FIG. 1 in a disconnected arrangement and with a top portion of the wire connector removed, according to an exemplary embodiment.

FIG. 4 is a perspective view of the wire connector system of FIG. 3 in a connected arrangement, according to an exemplary embodiment.

FIG. 5 is a perspective view of a first end of a portion of the wire connector of FIG. 1 connected to a first wire, according to an exemplary embodiment.

FIG. 6 is a perspective view of a second end of a portion of the wire connector of FIG. 1 connected to a second wire, according to an exemplary embodiment.

FIG. 7 is an exploded view of the wire connector of FIG. 1, according to an exemplary embodiment.

FIG. 8 is a perspective view of a contact within the wire connector of FIG. 1, according to an exemplary embodiment.

FIG. 9 is a top view of the contact of FIG. 8, according to an exemplary embodiment.

FIG. 10 is an end view of the contact of FIG. 8, according to an exemplary embodiment.

FIG. 11 is a perspective view of a contact within the wire connector of FIG. 1, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a wire-to-wire poke home connector system includes a wire-to-wire poke home connector, which is structured to receive a first wire and a second wire. The connector can include a housing having a first port and a second port, which receive the respective first wire and second wire therein. The housing may include a first portion and a second portion structured to couple to the first portion to enclose one or more electrical contacts therein. The housing is structured such that the first port and the second port are axially offset such that when the first and second wires are received within the connector, the first and second wires are disposed in a side-by-side arrangement to reduce a lengthwise footprint of the connector. The arrangement of this system allows for the electrical connection of both similar and dissimilar wires (including both solid and stranded wires) while minimizing an axial dimension of the connector.

In various embodiments, the connector is configured for connecting a conductive core of each of the first and second wire with an electrical component, such as a printed circuit board (PCB). In other embodiments, the connector can house one, two, three, or more wires. In yet other embodiments, the connector can be used to connect two or more wires, without additional electrical components, such as PCBs. It should be appreciated that the electrical contact is not limited by a number of wire positions or types of connections that the electrical contact may make.

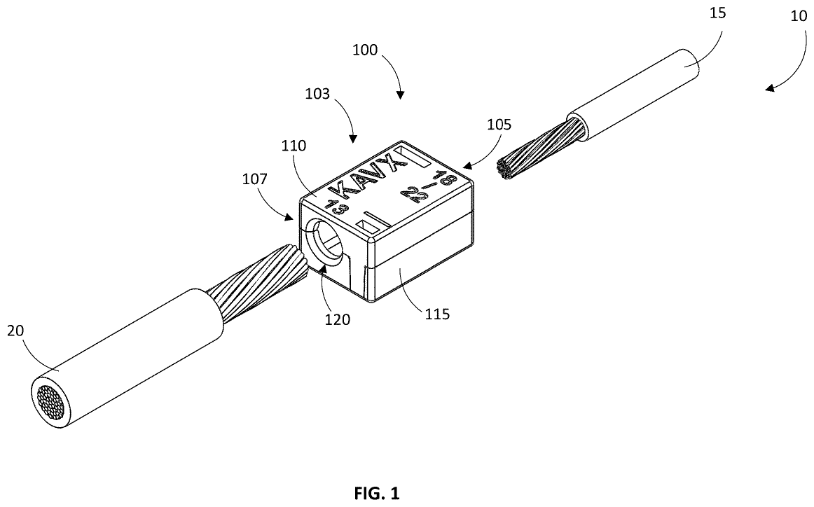

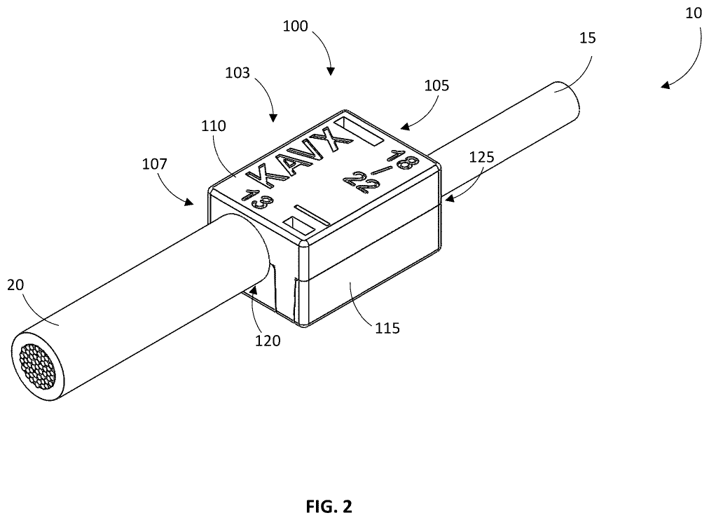

Turning now to the figures and referring specifically to FIGS. 1 and 2, a wire-to-wire poke home connector system 10 is shown, according to at least one embodiment. As shown, the connector system 10 includes a connector 100, which is structured to receive a first wire 15 and a second wire 20. FIG. 1 shows the connector system 10 in a disconnected arrangement and FIG. 2 shows the connector system 10 in a connected arrangement, where the first wire 15 and the second wire 20 are received within the connector 100. In various embodiments, the first wire 15 and the second wire 20 are a same type and size of wire. In other embodiments, the first wire 15 and second wire 20 are of a dissimilar type and/or size. For example, in various embodiments, the first wire 15 may have a greater diameter than the second wire 20. In other embodiments, the second wire 20 may have a greater diameter than the first wire 20. In yet other embodiments, at least one of the first wire 15 and second wire 20 are stranded. In some embodiments, at least one of the first wire 15 and the second wire 20 are solid.

As shown, the connector 100 includes a housing 103 having a first end 105 and a second end 107 opposite the first end 105. The housing 103 may include a first portion 110 (e.g., a cover) and a second portion 115 (e.g., a base), where the first portion 110 is structured to couple to the second portion 115. In various embodiments, the first portion 110 and the second portion 115 are structured to removably couple such that the housing 103 can be selectively assembled and disassembled. In other embodiments, the first portion 110 and the second portion 115 are structured to fixedly couple such that the housing 103 cannot be disassembled. In various embodiments, the first portion 110 and/or the second portion 115 are made of an electrically insulating material. In other embodiments, the first portion 110 and/or the second portion 115 include an insulating layer disposed on an outer surface and/or an inner surface. In various embodiments, the first portion 110 and/or the second portion 115 may include one or more recesses, apertures, ridges, grooves, or other similar features to facilitate mounting or coupling to a substrate (e.g., a PCB).

As shown, when the housing 103 is assembled, the first portion 110 and the second portion 115 form a first port 125 and a second port 120. For example, as shown in FIGS. 1 and 2, the first port 125 and the second port 120 are formed between the first portion 110 and the second portion 115 such that each of the first portion 110 and the second portion 115 form a half of each of the first and second ports 125, 120. In other embodiments, the first portion 110 may define the first port 125 and the second portion 115 may define the second port 120, or vice versa. Although the figures show the first port 125 being formed on the first end 105 of the housing 103 and the second port 120 being formed on the second end 107 of the housing 103, in various embodiments, the ports 120, 125 may be formed on a same end, opposite ends, or between the ends 105, 107 of the housing 103. For example, in an embodiment, one of the first port 125 or the second port 120 can be disposed on a side of the housing 103 between the ends 105, 107 and the other of the first port 125 and the second port 120 can be disposed at one of the ends 105, 107. In other embodiments, both of the first port 125 and the second poet 120 are formed at one of the ends 105, 107. As shown in FIG. 2, the first port 125 is structured to receive the first wire 15 and the second port 120 is structured to receive the second wire 20. In some embodiments the first port 125 is structured to receive the second wire 20 and the second port 120 is structured to receive the first wire 15. In yet other embodiments, both the first port 125 and the second port 120 are structured to receive either the first wire 15 or the second wire 20.

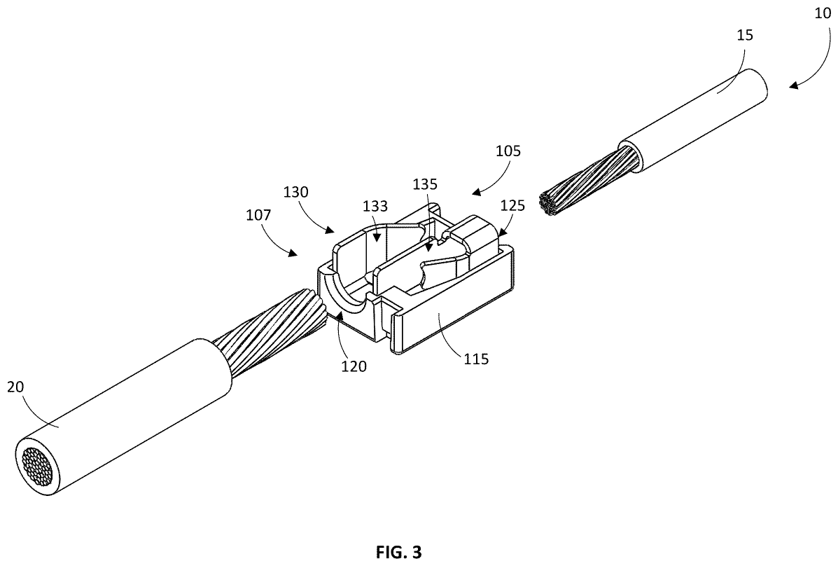

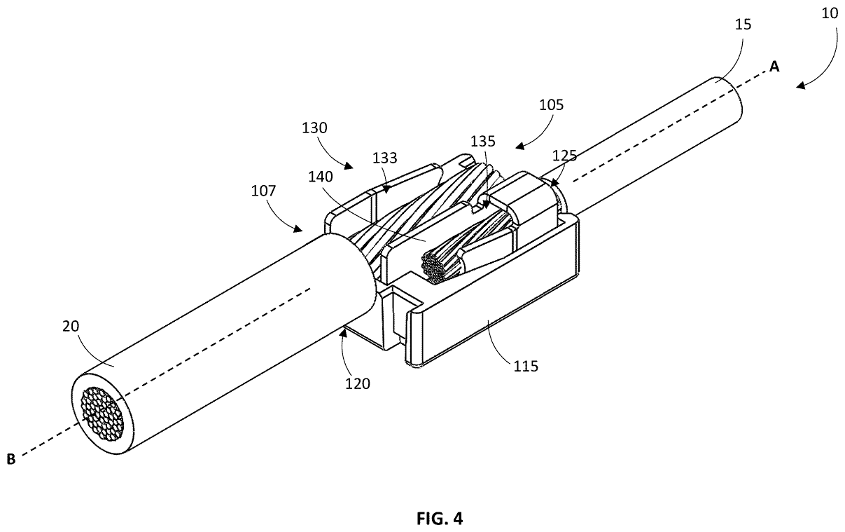

FIGS. 3 and 4 illustrate the connector system 10 with the first portion 110 of the connector 100 removed. As illustrated, the second portion 115 includes a contact member (“contact”) 130, which is structured to form an electrical connection between the first wire 15 and the second wire 20 when both are inserted into the ports 125, 120 respectively. In various embodiments, the second portion 115 includes a formed recess having a shape complementary to a shape of the contact member 130 such that the contact member 130 may be received within the recess of the second portion 115. In various embodiments, the second portion 115 and the contact member 130 may be coupled together using one or more coupling means. In some embodiments, the one or more coupling means may include soldering, brazing, adhesives, fasteners, or any other suitable means known in the art. In various embodiments, the contact member 130 can be press fit into the second portion 115. In yet other embodiments, the contact member 130 may sit within the second portion 115 and be readily removable therefrom.

As shown, the contact member 130 has a first contact channel 135 and a second contact channel 133, which are aligned with the first port 125 and the second port 120, respectively. The first contact channel 135 and the second contact channel 133 joined by a common wall 140, which extends in a direction substantially perpendicular to an upper surface of the second portion 115. When the first wire 15 and the second wire 20 are inserted into the contact member 130, as shown in FIG. 4, the first wire 15 is aligned along a first axis A defined by the first channel 133 (and the first port 120) and the second wire is aligned along a second axis B defined by the second channel 135 (and the second port 125), which is offset from the first axis A. In various embodiments, the first axis A and the second axis B, and thus the corresponding first channel 135 and the second channel 133 and first port 125 and second port 120, are substantially parallel. Because the first axis A and the second axis B are offset, the first and second wires 15, 20 can be arranged side-by-side within the connector 100, which reduces a footprint of the connector 100 (e.g., as opposed to end-to-end arrangement).

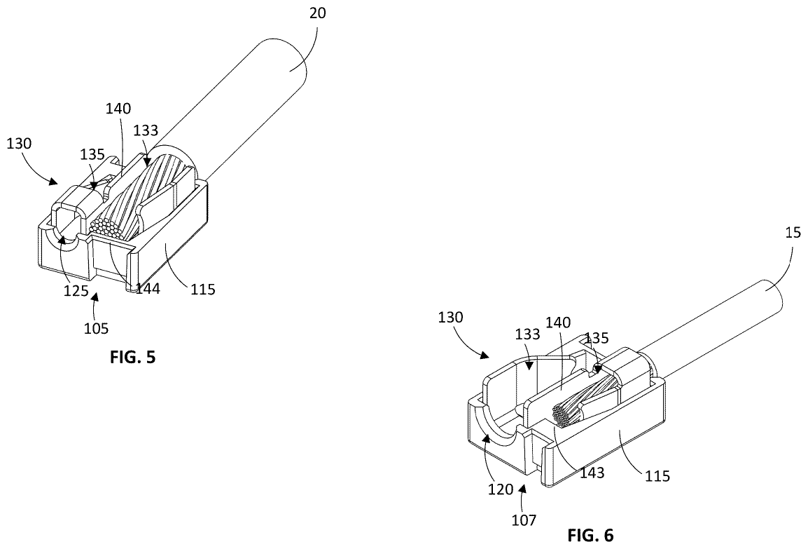

As shown in FIGS. 5 and 6, when the first wire 15 is fully inserted within the first port 125, a side of the first wire 15 contacts the wall 140 (e.g., due to a force applied upon the wire by a contact beam of the contact member) and an end of the wire 15 abuts an interior ridge 143 within the second portion 115. Similarly, when the second wire 20 is received within the second port 120, a side of the second wire 20 contacts the wall 140 and an end of the second wire 20 abuts an interior ridge 144 within the second portion 115. As shown, the ridge 143 is disposed adjacent to the second end 107 and the ridge 144 is disposed adjacent the first end 105. In various embodiments, each of the first wire 15 and the second wire 20 are press fit in the ports 125, 120 to facilitate electrical connection therebetween.

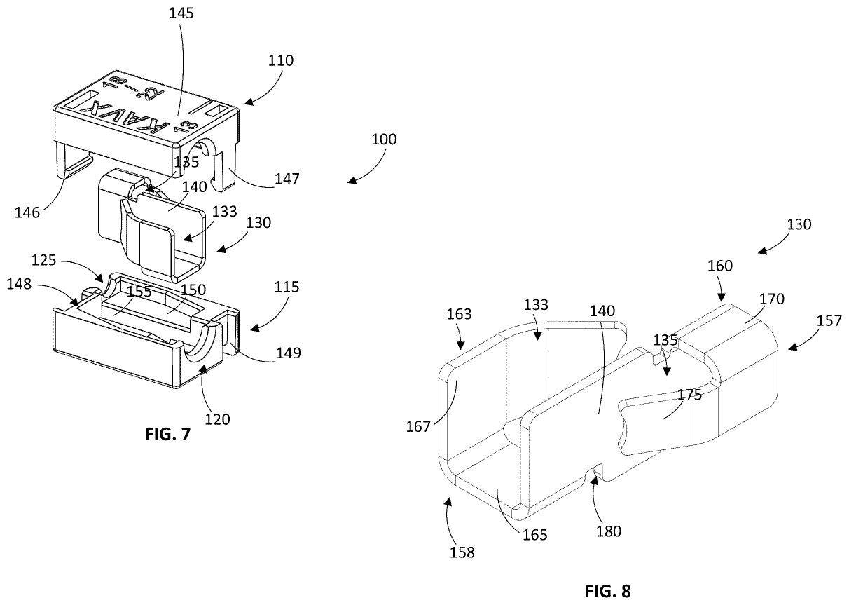

FIG. 7 shows an exploded view of the connector 100, according to an exemplary embodiment. As described above, the first portion 110 and the second portion 115 are structured to mutually couple. As shown in FIG. 7, the first portion 110 may include hooked tabs 146 and 147, which extend outward from a cover region 145 of the first portion 110. In various embodiments, the hooked tab 146 may be disposed adjacent the first end 105 of the connector 100 and the hooked tab 147 may be disposed adjacent the second end 107 of the connector 100. Although FIG. 7 shows the first portion 110 having two tabs 146, 147, in various embodiments, the first portion 110 may include any number of tabs to enable coupling to the second portion 115. As shown in FIG. 7, the second portion 115 includes grooves 148 and 149 and corresponding ledges or shelves, which are respectively structured to engage with the tabs 146 and 147.

As shown, the second portion 115 includes recesses 150 and 155 disposed within an upper surface of the second portion 115. The recesses 150 and 155 are structured to receive the channels 133 and 135 of the connector member 130, respectively. In various embodiments, the connector member 130 may be press fit within the recesses 150, 155 of the second portion 115. In some embodiments, recesses 150 and/or 155 may include one or more ridges, indents, detents, protrusions, or other features structured to engage with the contact member 130 to facilitate retention within the second portion 115. Accordingly, when the connector 100 is assembled, the contact member 130 may be positioned within the recesses 150, 155 of the second portion 115, and the first portion 110 may be coupled to the second portion 115 via the tabs 146, 147 engaging with the grooves 148, 149. Thus, when the connector 100 is assembled the contact member 130 is disposed between the first portion 110 and the second portion 115.

FIG. 8 is a perspective view of the contact member 130 according to an embodiment. The contact member 130 has a first end 157 and a second end 158 opposite the first end 157, where the first end 157 may be aligned with the first end 105 of the contact 100 and the second end 158 may be aligned with the second end 107 of the contact 100 when the contact member 130 is positioned within the second portion 115. As shown, the contact member 130 may be structured such that the first channel 135, which is configured to receive the first wire 15, is adjacent the first end 157 of the contact member 130 and the second channel 133, which is configured to receive the second wire 20, is adjacent the second end 158 of the contact member 130.

The first channel 135 and the second channel 133 are formed by a corresponding first beam 160 and a second beam 163, which are each coupled to or integrally formed with the wall 140. As shown, the first beam 160 includes a first section 170 and a second section 175, where the first section 170 extends in a direction substantially perpendicular to the wall 140 and forms an approximate U-shape to define a width of the channel 135. The second section 175 extends in a lengthwise direction parallel to the wall 140 such that the second section 175 extends from first section 170 (e.g., extending from a leg of the generally U-shaped first section 170) adjacent the first end 157 toward the second end 158 and defines a length of the channel 135. Similarly, the first section 165 extends in a direction substantially perpendicular to the wall 140 and forms a U-shape that defines a width of the channel 133. The second section 167 then extends in a lengthwise direction parallel to the wall 140 such that the second section 167 extends from the first section 165 adjacent the second end 158 toward the first end 157 and defines a length of the channel 133. In various embodiments, a width of the channel 133 is greater than a width of the channel 135. In some embodiments, the width of the channels 133, 135 are the same. In yet other embodiments, the channel 135 is wider than the channel 133. In an embodiment, the arrangement of the first beam 160 mirrors the arrangement of the second beam 163 (including either or both of shape and dimensions), except that each beam corresponds to an opposite end and side of the contact member as illustrated in FIG. 8.

In some embodiments, each of the second sections 175, 167 is tapered or angled with respect to the wall 140 such that a distance between the wall and the second sections 175, 167 decreases with distance from the corresponding first sections 170, 165 (e.g., the distance between the wall 140 and a distal end of the second sections 175, 167 is less than the distance between the wall 140 and a proximal end of the second sections 175, 167 that is adjacent the first sections 170, 165, respectively). For example, in various embodiments, the second section 175 is tapered such that a distance between the wall 140 and the second section 175 decreases with increased distance from the first end 157. Similarly, in various embodiments, the second section 167 is tapered such that a distance between the wall 140 and the second section 167 decreases with increased distance from the second end 158. The tapered structure of each of the second ends 167 and 175 may facilitate retaining the wires 20 and 15, respectively, within the contact member 130 (and thus within the connector 100). Additionally, the distal end of one or both of second sections 175, 167 may have a concave (or otherwise grooved) shape design to generally conform to or otherwise hold an inserted wire in place. In other embodiments, the distal end of one or both of second sections 175, 167 may be shaped to have a substantially straight or flat edge.

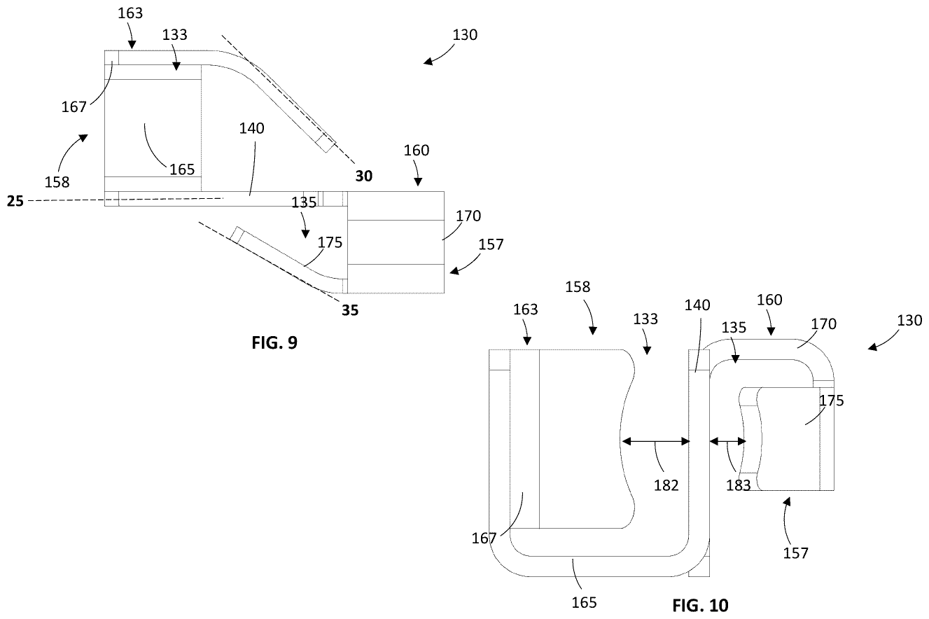

In some embodiments, the distal end of the second section 175 of the first beam 160 may extend to be in a position aligned with the distal end of the second section 167 of the second beam 163. In yet other embodiments, the distal end of the second section 167 of the second beam 163 may extend to be in a position aligned with a portion of the first section 170 of the first beam 160. Similarly, the distal end of the second section 175 of the first beam 160 can extend to be in a position aligned with a portion of the first section 165 of the second beam 163. In other embodiments, the second sections 175, 167 of the first beam 160 and second beam 163, respectively, can be angled relative to the wall 140. For example, as shown in FIG. 9, the second section 167 of the second beam 163 is structured to extend toward the wall 140 such that an axis 30 of the second beam 163 is angled relative to an axis 25 of the wall 140. Similarly, the second section 175 of the first beam 160 is structured to extend toward the wall 140 such that an axis 35 of the first beam 160 is angled relative to the axis 25 of the wall 140. In some embodiments, the axis 30 and the axis 35 may be parallel. In some embodiments, an angle between the axis 30 and the axis 25 is greater than an angle between the axis 35 and the axis 25. In other embodiments, the angle between axis 30 and the axis 25 is greater than an angle between axis 35 and the axis 25. In some embodiments, the angle between the axis 25 and the axis 30 and the angle between the axis 25 and the axis 35 are approximately the same. In various embodiments, the distal end of the second section 175 of the first beam 160 is spaced a distance 183 from the wall 140 and the second section 167 of the second beam 163 is spaced a distance 182 from the wall 149, as shown in FIG. 10. In some embodiments, the distance 183 is greater than the distance 182. In other embodiments, the distance 183 is less than the distance 182. In yet other embodiments, the distance 183 is approximately the same as the distance 182.

In various embodiments, the contact member 130 is formed from a single component. Accordingly, in some embodiments, the contact member 130 may be formed by first rolling or cutting a shaped member from sheet metal and subsequently forming (e.g., rolling, bending, etc.) the shaped member such that it has the features of the contact member 130. Although FIG. 8 shows the first section 170 of the first beam 160 being disposed on an end of the contact member 130 that is opposite the first section 165 of the second beam 163, in various embodiments, the contact member 130 may be structured such that the first sections 170 and 165 are disposed on a same end of the contact member 130. In such embodiments, the first and second wires 15, 20 would then be insertable into the connector 100 on a same end. In some embodiments, the contact member 130 may include one or more notches or protruding features 180 disposed within the wall 140 to facilitate positioning and placement of the contact member 130 within the second portion 115 of the connector 100.

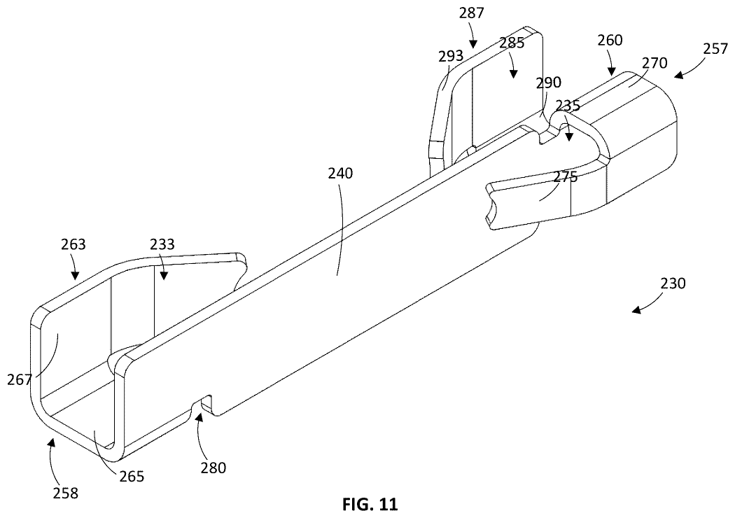

In yet other embodiments, the connector 100 may include a contact 230 structured to receive three wires, as shown in FIG. 11. In various embodiments, the elements 233-280 of the contact 230 are respectively equivalent to the elements 133-180 of the contact 130. As shown in FIG. 11, the contact 230 may include a third channel 285 formed by a third beam 287. The third beam 287 includes a first section 290 and a second section 293. As shown, the first section 290 forms a U-shape relative to the wall 140 and the second section 293 extends from the first section 290 toward the wall 140. Although FIG. 11 shows the third channel 285 being disposed on a side of the wall 140 opposite the first channel 235, in various embodiments, the third channel 285 can be disposed on a side of the wall 140 opposite the second channel 230. Although FIG. 11 shows the third channel 285 being disposed on the first end 257 of the connector 230, in various embodiments, the third channel 285 can be disposed on either the first end 257 or the second end 258.

Notwithstanding the embodiments described above in reference to FIGS. 1-11, various modifications and inclusions to those embodiments are contemplated and considered within the scope of the present disclosure.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A wire-to-wire connector comprising:
a housing defining a first port and a second port; and
a contact member disposed within the housing;
wherein the contact member defines a first channel and a second channel separated by a wall, the first channel defining a first axis and the second channel defining a second axis offset from the first axis, the first axis and the second axis being substantially parallel; and
wherein the first channel is aligned with the first port and the second channel is aligned with the second port.

2. The connector of claim 1, wherein the housing comprises a first end and a second end opposite the first end.

3. The connector of claim 2, wherein the housing comprises a first portion and a second portion, the first portion being structured to couple to the second portion.

4. The connector of claim 3, wherein the first portion comprises a first tab and a second tab;
wherein the second portion comprises a first groove and a second groove; and
wherein the first tab is structured to engage with the first groove and the second tab is structured to engage with the second groove.

5. The connector of claim 4, wherein the first tab and the first groove are disposed at the first end, and the second tab and the second groove are disposed at the second end.

6. The connector of claim 2, wherein the first port is disposed at the first end and the second port is disposed at the second end.

7. The connector of claim 3, wherein the first port and the second port are formed between the first portion and the second portion.

8. The connector of claim 1, wherein the contact member comprises a first beam and a second beam, the first beam forming the first channel and the second beam forming the second channel.

9. The connector of claim 8, wherein each of the first beam the second beam comprises a first section and a second section, the first section extending in a direction substantially perpendicular to the wall and the second section extending from the first section in a direction substantially parallel to the wall.

10. The connector of claim 9, wherein the first section of the first channel defines a width of the first channel and the second section of the first channel defines a length of the first channel, and wherein the first section of the second channel defines a width of the second channel and the second section of the second channel defines a length of the second channel.

11. The connector of claim 9, wherein the second section is tapered such that a distance between the second section and the wall decreases with increased distance from the first section.

12. A wire-to-wire connection system comprising:
a connector having a first port and a second port opposite the first port;
a first wire; and
a second wire;
wherein the first wire is structured to be received in the first port and the second wire is structured to be received in the second port to form an electrical connection with the first wire; and
wherein the first port is aligned along a first axis and the second port is aligned along a second axis, the first axis and the second axis being substantially parallel.

13. The system of claim 12, wherein the connector comprises:
a housing defining a first port and a second port;
a contact member disposed within the housing;
wherein the contact member defines a first channel and a second channel separated by a wall, the first channel defining a first axis and the second channel defining a second axis offset from the first axis, the first axis and the second axis being substantially parallel; and
wherein the first channel is aligned with the first port and the second channel is aligned with the second port.

14. The system of claim 13, wherein the contact member is positioned within a recess disposed within a portion of the housing.

15. The system of claim 12, wherein at least one of the first wire or the second wire is solid.

16. The system of claim 12, wherein at least of the first wire or the second wire is stranded.

17. The system of claim 12, wherein the first wire and the second wire are different sizes.

18. The system of claim 13, wherein the housing comprises a cover and a base, the cover structured to couple to the base, and wherein the contact member is positioned within the base.

19. The system of claim 13, wherein the contact member consists of a single component.

20. The system of claim 12, wherein the contact member comprises a first beam and a second beam, the first beam forming the first channel and the second beam forming the second channel; and
wherein each of the first beam the second beam comprises a first section and a second section, the first section extending in a direction substantially perpendicular to the wall and the second section extending from the first section in a direction substantially parallel to the wall.
